(19) United States
(12) Patent Application Publication
(10) Pub. No.: US 2010/0072430 A1
(43) Pub. Date: Mar. 25, 2010

(54) Compositions of carbon nanosheets and process to make the same

(76) Inventors: John S. Gergely, Avondale, PA (US); Edwin S. Marston, Wilmington, DE (US); Shekhar Subramoney, Hockessin, DE (US); Lu Zhang, Midlothian, VA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/418,903

(22) Filed: May 5, 2006

Related U.S. Application Data
(63) Continuation-in-part of application No. 11/250,336, filed on Oct. 14, 2005.

(51) Int. Cl. H01B 1/04; H01B 1/02; B01J 19/12

(52) U.S. Cl. 252/504; 252/502; 252/506; 204/157.63; 977/755

(57) ABSTRACT

This invention relates to free-flowing compositions of carbon nanosheets and core-shell particles, and to a plasma-torch process for making them.

This application is a continuation-in-part of U.S. application Ser. No. 11/250,336, filed Oct. 14, 2005, which is incorporated in its entirety as a part hereof for all purposes.

### TECHNICAL FIELD

This invention relates to a composition of carbon nanosheets and core-shell particles, and a process for making such a composition.

### BACKGROUND

Nanostructured forms of carbon such as buckminsterfullerenes, nanotubes and nanofibers have attracted significant attention from the scientific community the world over for the last two decades. Among these, the single-walled variant of carbon nanotubes is the subject of the most intense scrutiny at present. This is due to various studies (both theoretical and experimental) that have demonstrated that single-walled carbon nanotubes have unique physical and/or electronic properties due to the inherent in-plane characteristics of the single layer of graphite (a single plane containing a hexagonal array of carbon atoms) from which the tube is essentially formed.

Depending on the desired end-products, several methods are known in the art to produce different nanostructured forms of carbon. For example, laser ablation and arc-discharge processes have been used to vaporize carbon to produce buckminsterfullerenes, as disclosed by Kroto et al, in Nature, 318, 1985, 162; and Krätschmer et al, in Nature, 347, 1990, 354. Subsequently, arc-discharge experiments at higher pressures of inert gas were used to synthesize multi-walled carbon nanotubes in the growth that occurs on the face of the negative electrode, as disclosed by Iijima in Nature, 354, 1991, 56. Arc-discharge with anodes containing transition metals have been used to successfully synthesize single-walled nanotubes as well, as disclosed almost simultaneously by Iijima et al, and Bethune et al, in Nature, 363, 1993, 603 and 605, respectively. Subsequently, laser ablation as well as chemical vapor deposition experiments were also used to synthesize single-walled nanotubes, by Thess et al, Science, 273, 1996, 483; and Kong et al, Nature, 395, 1998, 878.

Theoretical and experimental studies have shown that the single sheet of graphite has excellent in-plane mechanical properties such as strength and elastic modulus. Experimental studies aimed at measuring the tensile strength of the graphite sheet by various groups using either graphitic scrolls or single-walled nanotubes indicate that the tensile strength would be on the order of several tens of GPas (gigaPascals, 10⁹ Newtons/m²), with specific tensile strength of a single layer in a multi-walled carbon nanotube being about 100 times that of steel. Young's modulus measurements indicate that the single sheet of graphite is extremely stiff as well, with the modulus exceeding 1 TPa (teraPascal, 10¹² Pascals). The single sheet of graphite also has excellent electrical and thermal conductivities. With room temperature electrical resistivity below 10⁻⁷ Ωm and thermal conductivities exceeding 2000 W/mK (about four times as high as that of copper), it would appear to be an excellent composite reinforcement at the nanometer level.

However, a single-walled carbon nanotube, though built up of a single-layer of graphite, essentially has a surface that is identical to the basal plane (0002) of graphite. This fact renders as-produced single-walled carbon nanotubes difficult to disperse unless their surfaces are modified by high levels of chemical functionalization to render them dispersible in various polymers. Various carbon nanotube side-wall functionalization schemes have been investigated to render single-walled carbon nanotubes dispersible in various polymers; for example, diazonium as disclosed by Bahr et al, in J. Am. Chem. Soc., 123, 2001, 6536; fluorination as disclosed by Mickelson et al, in Chem. Phys. Lett., 296, 1998, 188; and radical chemistry as disclosed by Ying et al., in Org. Lett., 5, 2003, 1471.

By comparison, a single sheet of carbon that is not rolled-up but presents a large number of open edge sites (hydrogen-bonding sites) would not only possess all of the attractive mechanical and electronic properties of the graphite sheet described above, but would be inherently dispersible in polymer media as well.

Thin, layered carbon products having a graphitic structure are known to have been produced on substrates. WO 00/40508 describes the production of tubular or film-like carbon sheets on substrates that can be either metallic or semiconducting in nature. These materials are produced from a mixture of methane and hydrogen where the methane concentration is between 8 and 10 percent.

A similar structure has also been obtained on a wide variety of substrates by inductively-coupled, radio-frequency-plasma-enhanced chemical vapor deposition from methane diluted with hydrogen, as disclosed by Wang et al, in Carbon, 42, 2004, 2867, and in WO 05/84172.

A need therefore remains for a thin, layered carbon product that is unsupported, and thus free flowing, as manufactured. Such a product would be powdery, and could be easily handled for subsequent functionalization chemistries, or for incorporation and dispersal into a polymeric matrix for producing compositions, while offering the advantageous properties of a single sheet of graphite as described above.

### SUMMARY

One embodiment of this invention is a composition that includes (a) carbon nanosheets, and (b) core-shell particles that each comprises a metal-rich core and a carbon-rich shell.

Another embodiment of this invention is a process for making a composition as described above by

(a) introducing a hydrocarbon reactant and a metal carbonyl reactant into a flowing gas stream in which the reactants are contacted, and

(b) quenching the reaction of the hydrocarbon and the metal carbonyl to recover the product thereof;

wherein at the point of introduction of the hydrocarbon into the gas stream the gas is in the form of a plasma; and

wherein the metal carbonyl is introduced downstream from the hydrocarbon.

A composition of this invention has useful properties related to electrical conductivity, and in that and other properties is comparable to graphite, and it imparts electrical conductivity to blends of the composition with other materials.

### BRIEF DESCRIPTION OF THE DRAWINGS

FIG. 1 is a drawing of a carbon nanosheet composed of three graphene plates.

FIG. 2 is a drawing of a gas entrainment and conditioning apparatus.

FIG. 3 is a drawing of a DC plasma torch reactor.

FIG. 4 is a drawing of a multi-port reactor.

FIG. 5 is a graphical representation of comparative particle size distributions.

FIGS. 6 and 7 each represent high resolution TEMs of the product of Example 1.

FIG. 8 represents a high resolution TEM of carbon black.

FIG. 9 represents a high resolution TEM of acetylene black.

### DETAILED DESCRIPTION

This invention provides a composition of carbon nanosheets and core-shell particles. Also provided is a process for making the composition.

A carbon nanosheet is a two-dimensional graphite structure characterized by nanoscale thickness and an open geometry in terms of its surfaces and edges. A carbon nanosheet has a high surface-to-volume ratio, and its sharp edges are good sites for functionalization and other types of bonding.

The carbon nanosheet is made up of a stack of graphene plates, each of which is essentially monatomic graphite and may have a thickness of about 0.35 nm. There may be 2 to 8 or more, and are often 4 to 6 or more, graphene plates stacked in the c-direction forming the nanosheet, but in some instances just 1, 2 or 3 such plates are present in a nanosheet. Depending on the number of graphene plates present, the nanosheet may thus have a thickness of up to 10 nm, but more often has a thickness in the range of about 3 to about 5 nm, and in some instances it has a thickness of about 2 nm or less, or about 1 nm or less.

A carbon nanosheet generally has at least one lateral dimension that is between about 10 and 500 nanometers, and more often between about 25 and about 300 nanometers. This measurement of lateral dimension can be for either the length, the width or for both such dimensions, as opposed to the thickness of the sheet, which thus gives the sheet its planar form and appearance. A carbon nanosheet has a surface area, as measured by the Braunauer-Emmett-Teller (“BET”) method [disclosed in Journal of the American Chemical Society, Volume 60, Page 309 (1938)] of greater than about 250 m²/g, often greater than about 350 m²/g, and in some instances greater than about 500 m²/g.

A carbon nanosheet has, in general, a relatively smooth surface topography and a uniform thickness across the entire plane of the sheet. It may, however, be slightly folded, twisted and/or corrugated with a small radius of curvature, as caused by the presence of 5- or 7-membered carbon rings within the hexagonal lattice of interlocking 6-membered rings. The nanosheet may thus have sharp ridges resulting from folds or a corrugated surface, but in general not at a high density. Despite the presence of rings that have fewer or more than 6 carbons, however, most if not all bond angles in the network of carbon atoms that forms the nanosheet are approximately if not exactly 120 degrees.

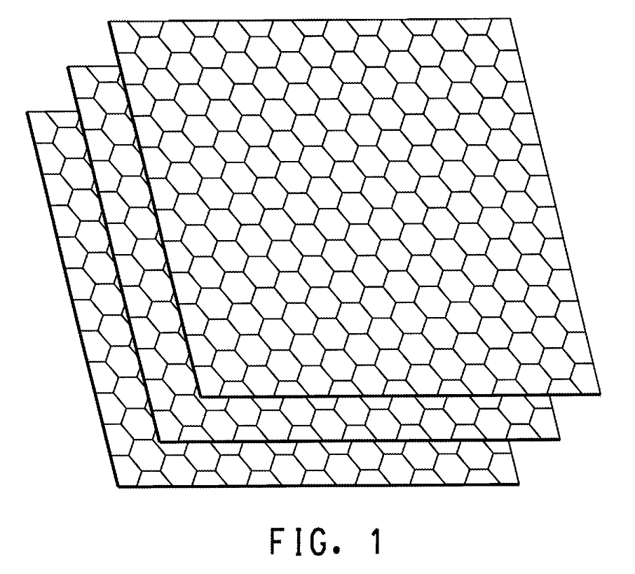

FIG. 1 shows a carbon nanosheet made up of 3 graphene plates. This depiction is somewhat idealized in terms of the presence of only 6-membered carbon rings, and the resulting absence of folds, twists or corrugation, and the precisely ordered stacking of plates of the same size. Graphene plates may have a variety of shapes and sizes, and may overlap each other in the stack in papier-mâché fashion. The c-direction spacing between the graphene plates in the stack forming the nanosheet is larger than the spacing of the 0002 plane of bulk graphite.

The carbon nanosheets used in the compositions of this invention differ from exfoliated graphite, which is generally prepared from well-crystallized natural flake graphite by the very rapid heating of graphite intercalation compounds. As the vaporizing intercalated substances force the graphite layers apart, the exfoliated graphite assumes an accordion-like shape with an apparent volume often hundreds of times that of the original graphite flakes. The surface area of exfoliated graphite, however, is typically only in the 100-200 m²/g range.

A core-shell particle that is contained along with carbon nanosheets in a composition of this invention has a metal-rich core and a carbon-rich shell. In certain embodiments, this particle may be viewed as being a type of nanocomposite in which the core is encapsulated by or coated with the carbon-rich material of the shell, in which the carbon content is typically at least about 60 wt %, and is more often at least about 75 or 85 wt %, based on the total weight of all components in the shell, with the other components in the shell typically including metal carbides and/or metal oxides.

The metal-rich core of the particle may be viewed as being embedded in layers of the carbon-rich material, which layers may have a turbostratic (two-dimensionally ordered) structure or may have an onion-like shape; but are in any event separate from, and are to be distinguished from, the graphene plate(s) from which a carbon nanosheet is formed. The metal present in the metal-rich core may be selected from a variety of metals, and includes, for example, metals such as essentially any actinide, lanthanide, ferromagnetic, paramagnetic or transition metal. The metal is most often one or more metals such as chromium, cobalt, iron, manganese, molybdenum, nickel, tungsten or vanadium. The metal content in the core of the particle is typically at least about 60 wt %, and is more often at least about 75 or 85 wt %, based on the total weight of all components in the core.

The longest dimension of the particle, taken with respect to its entire volume and regardless of its shape, is typically in the range of about 1 to about 20 nm, more often is in the range of about 2 to about 10 nm, and most often is in the range of about 2 to about 5 nm. This type of core-shell particle is oxidatively passivated by virtue of the carbon-rich shell.

In a composition of this invention, carbon nanosheets are present in an amount of at least about 80%, and more often at least about 90%, by volume of the composition; and are present in an amount of at least about 50%, and more often at least about 60%, by weight of the composition, with the balance in each case being made up of the core-shell particles.

A composition provided by this invention is unsupported in the sense that it is not formed on a substrate, and there is thus no substrate material present or remaining with or in the composition as formed. As a result, the composition excludes any substrate or support material as might be used to make other kinds of materials, or the remnants or residue thereof, and is free-flowing and powder-like in nature. It can be easily handled, and is thus useful as a blend component, filler or additive in a number of products where the inclusion of carbon is beneficial, such as those products whose electrical properties, such as conductivity, are important. Co-filed, commonly-assigned application entitled “Carbon-loaded Polymeric Blends”, and bearing docket number CL-3164, which is incorporated in its entirety as a part hereof for all purposes, describes the admixture of a composition as provided by this invention with a polymeric material.

A composition of this invention may be prepared by the process of this invention, one embodiment of which may be described as follows. A metal carbonyl, such as a transition metal carbonyl, is combined with a hydrocarbon in a flowing gas stream wherein the gas in the stream is either in plasma form or is in a cooled, post-plasma form. The gas used in the flowing stream comprises one or more inert gases, which may be selected from the group of helium, neon, argon and xenon. The reaction is followed by a quenching step to form the composition.

The plasma may be formed using conventional methods in which an ionizable gas is subjected to a sufficiently high voltage such that ionization occurs to form a plasma. A plasma suitable for use herein may be formed by a variety of methods including, without limitation, the use of a direct current (DC) plasma torch, a radio-frequency (RF) plasma torch, carbon arcs, lasers, electron beams and the like. Carbon arcs are less preferred because of the potential interference from unwanted carbon contributed by the carbon electrode. The gas from which the plasma is formed is not itself ionic in nature until being converted into a plasma, and may thus be selected from at least one inert gas, preferably argon. The plasma thus prepared is then caused to flow into a reaction chamber wherein a hydrocarbon gas or liquid and a metal carbonyl vapor are introduced.

In one typical embodiment, the hydrocarbon is introduced into the plasma at the hottest point where the plasma exits the plasma torch. The metal carbonyl is then introduced into the gas stream downstream, in the flow of the reactor, from the entry point of the hydrocarbon. It is whether, at the entry point of the metal carbonyl, the gas in the flowing stream still exists in plasma form or not. The gas may be in plasma form, or by the time it has reached the point of entry of the metal carbonyl, the gas may be in post-plasma form as it may have cooled sufficiently to have been reconstituted in non-ionic form. Whether or not it is plasma or post-plasma form, the gas is still quite hot as it will have a temperature of at least about 1000° C., and possibly at least about 2000° C.

In an alternative embodiment, however, a portion of the hydrocarbon is introduced into the plasma upstream from the introduction point of the metal carbonyl, while another portion of the hydrocarbon is employed as the carrier and/or make-up gas for the metal carbonyl input stream. In a further embodiment, the metal carbonyl may be cooled to below room temperature (“RT”, approximately 25° C.) prior to its introduction into the reactor. The flow of the plasma gas may be intermittent, but is preferably continuous. Introducing the hydrocarbon gas upstream from the metal carbonyl produces, in general, the smallest particle size, and the narrowest polydispersity, for the core-shell particles that are contained in the composition of this invention.

It is preferred that the hydrocarbon reactant be contacted with the metal carbonyl reactant in the substantial, if not complete, absence of hydrogen. Hydrogen is substantially absent from the reaction when, the amount of hydrogen present reduces the weight percent of carbon nanosheets obtained in the reaction product by less than about 40%, preferably less than about 20%, and more preferably less than about 10%, as compared with the weight percent of carbon nanosheets obtained in the product of a reaction that is run is the complete absence of hydrogen.

Any readily vaporized hydrocarbon may be employed, but alkanes having 1 to 5 carbons are preferred. Most preferred is methane. Essentially any metal carbonyl is suitable, and these are available commercially from suppliers such as Aldrich Chemical Company, Milwaukee, Wis. This includes without limitation transition metal hydrocarbons such as Fe(CO)₅, Ni(CO)₄, and Co(CO)₈. Preferred is Fe(CO)₅. A suitable range in flow rates of the reactants will depend upon the scale of the reaction apparatus used. It has been found, however, when using an apparatus of the general nature as described below, that a flow rate of a gas such as argon of about 14 L/min is satisfactory, a flow rate of a hydrocarbon such as methane in the range of about 0.1 to about 0.5 L/min is satisfactory, and a flow rate of a carbonyl such as Fe(CO)₅ in the range of about 0.01 to about 0.15 g/min is satisfactory.

A minimum volume flow rate of the carrier plus make-up gas is preferred in order for the process to operate effectively to produce useful quantities of the composition. In the process, a volume flow rate of carrier plus make-up gas of at least about 0.1 L/min, and preferably about 0.7 L/min, is recommended. Conversely, excessive carrier gas flow rates can result in excessively high concentrations of the metal carbonyl which results in rapid plugging of the injector tip.

The purpose of the make-up gas stream is to provide sufficient volume flow of the metal carbonyl-containing feed to permit good mixing to be obtained with the heated gas. If insufficient volume flow is provided, sufficient mixing with the heated gas is not obtained. It is possible to eliminate the make up gas stream and simply increase the feed rate of the carrier gas, but this may cause excess metal carbonyl to be entrained which may result in clogging of the injector port.

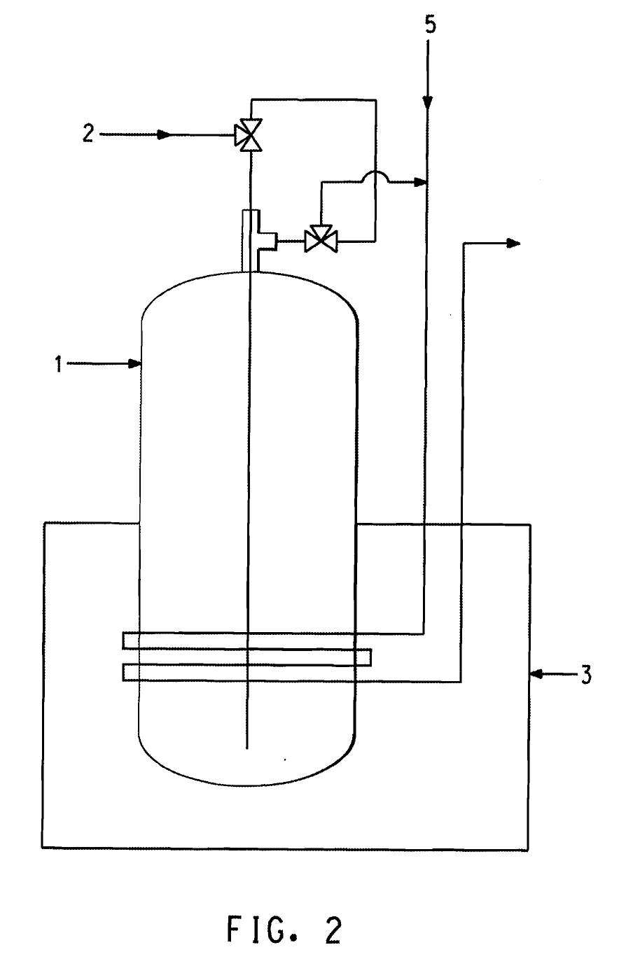

The means for introducing the hydrocarbon and metal carbonyl into the flowing heated gas stream in the reactor is not critical. Any suitable method for adding a known amount of vapor of a volatilizable liquid at a constant rate may be employed, as may any known method for flow monitoring and controlling of a hydrocarbon vapor. One approach is to combine the metal carbonyl vapor with the hydrocarbon by employing a vapor entrainment device, such as shown in FIG. 2, wherein the hydrocarbon vapor is bubbled through the metal carbonyl in liquid form. If the metal carbonyl is held at a constant temperature, as in a bath, the concentration of metal carbonyl entrained by the hydrocarbon vapor will be controlled, and will depend entirely upon the flow rate of the hydrocarbon. When the metal carbonyl is a solid at room temperature, as is the case for Co(CO)₈, it is necessary to heat the metal carbonyl to above its melting temperature in order to provide a vapor phase source of the metal carbonyl, and affect the bubbling method for metering the flow of metal carbonyl into the heated gas.

FIG. 2 shows a design for a vapor entrainment apparatus suitable for use in the present invention as a feeding device for the metal carbonyl. The vapor entrainment apparatus consists of a sealed cylinder 1, a carrier gas stream inlet 2, a constant temperature bath 3, and an exit port 4a connecting to a second gas stream called the “make up” gas which is fed in at inlet 5, combined with the carrier gas stream. The hydrocarbon gas feed inlet 5 serves to direct the hydrocarbon gas through the constant temperature bath as well, and then to the injection port 4b of a plasma torch reactor. As depicted in FIG. 2, the carrier gas containing the metal carbonyl is combined into the make-up gas stream and then cycled through the constant temperature bath. In one embodiment, at least one of the carrier gas and the make up gas are a hydrocarbon gas, such as methane.

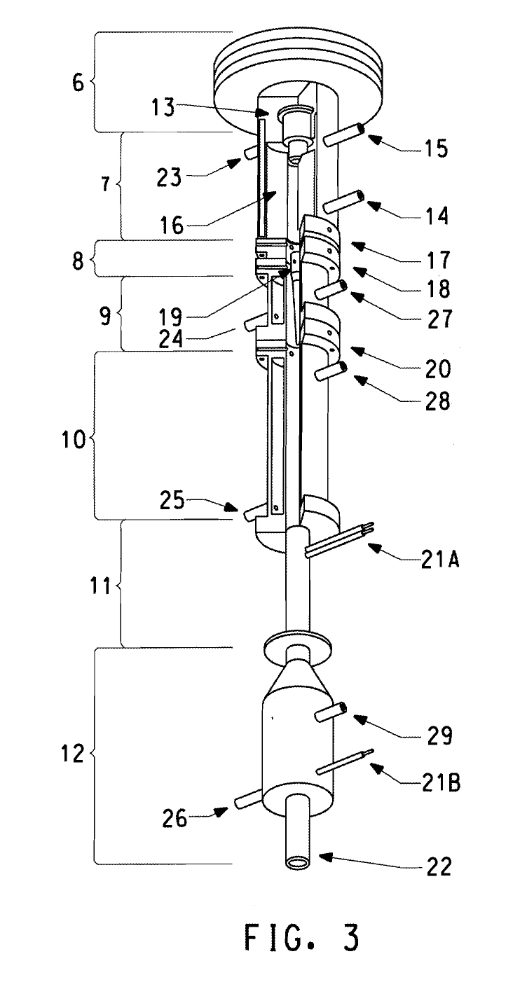

An apparatus employed as a vapor entrainment device as illustrated in FIG. 2 may be used in conjunction with a plasma torch as illustrated in FIG. 3. In the vapor entrainment device, or bubbler, the controlled temperature bath may be an iced salt brine at about −10° C. The cylinder 1, as shown in FIG. 2, may be a 150 cc cylinder, cleaned and evacuated, and then at least partially filled with a metal carbonyl. A carrier gas is fed through the liquid metal carbonyl in the cylinder. Downstream from the cylinder, the carrier gas may be combined with an additional stream called a “make up” gas, and the mixture is fed through the brine bath to ensure uniform controlled temperature of injection into the plasma stream. Methane is suitable for use as both the carrier gas and make-up gas.

A plasma torch reactor suitable for use in the process of this invention, as illustrated in FIG. 3, consists of seven sections, labeled 6 to 12. An electromagnet 6 surrounds a plasma gun 7 having a cathode 13 and annular anode 16 that generate plasma upon being energized. The electromagnet 6 produces an axial magnetic field in the direction of gas flow causing rotation of the electric arc between the cathode and anode, which provides improved uniformity in the production of the plasma from the plasma source gas and more homogeneous wear on the anode surface. Cooling water is admitted through port 14 and discharged through port 23. High purity inert gas is fed through feed port 15. A plasma gun is attached through a spacer 8 to a reactor/nozzle assembly 9. Spacer feed port 17 admits a hydrocarbon feed. The water cooled nozzle holder 18 supports a ceramic nozzle 19. Nozzle holder feed ports found in nozzle holder 18 admit the metal carbonyl feed stream from the vapor entrainment apparatus (shown in FIG. 2). The nozzle 19 discharges into a quench chamber 10. Helium is introduced through three ports, one of which is marked port 20, to aid the quench. The quench chamber is attached through an adapter 11 to a water-cooled product collector 12 containing a fine sintered INCONEL® filter (not shown). Provision for connections to pressure transmitters and temperature probes are at 21A and 21B. Filtered waste gases exit to a scrubber at 22. Various cooling water ports are numbered 24-29.

The nozzle assembly of FIG. 3 allows maintenance of one-dimensional flow in the axial direction with minimum back-mixing. Prevention of back mixing is thought to enhance product uniformity by preventing the build up of larger than desired particulate matter. This nozzle also provides a fast quench by providing cooling prior to gas entry into the rare-gas flushed quench chamber.

A plasma torch reactor as shown in FIG. 2 may, for example, be equipped with a modified Metco type MBN plasma gun (available from Sulzer Metco Inc., Westbury N.Y.), having a maximum power of 40 kW (500 A at 80 V). The plasma torch current may be set at 110 A. The plasma torch may be provided with a water-cooled copper anode, such as a Metco MB63, and a thoriated tungsten tip water-cooled copper cathode, such as Metco MBN430. The electromagnetic maybe water-cooled, machine wound and housed in a plexiglass enclosure. The magnet may be operated at 90% full scale voltage, for example about 35 volts. Below the plasma torch may be placed a 1.5-inch (3.8 cm) spacer with three ⅛-inch (3.175 mm) radial feed ports, two capped, and one used to feed a hydrocarbon at a rate, for example, of about 0.3 L/min. Below the spacer may be placed a 3-inch (7.6 cm) water-cooled nozzle holder containing a 3-inch (7.6 cm) ceramic nozzle (made by Insaco, Inc., Quakertown Pa.) and three radial input ports with feed injectors, two capped and the other to feed a metal carbonyl contained in a hydrocarbon carrier gas.

The main hydrocarbon feed stream may be introduced into the reactor below the exit of the torch and above the nozzle. The metal carbonyl containing feed stream may be introduced into the reaction zone of the nozzle assembly. Below the nozzle holder is typically a water-cooled quench chamber that has three radial input ports to provide additional quench using He fed at a rate, for example, of 5 L/min. through each of the ports for a total He quench of 15 L/min. Below the quench chamber, an adapter connects the quench chamber to a water-cooled, single-filter element product collector. The collector houses, for example, a 3 micrometer sintered INCONEL® 600 filter element. The product may be collected on the filter and removed therefrom in powder form for use.

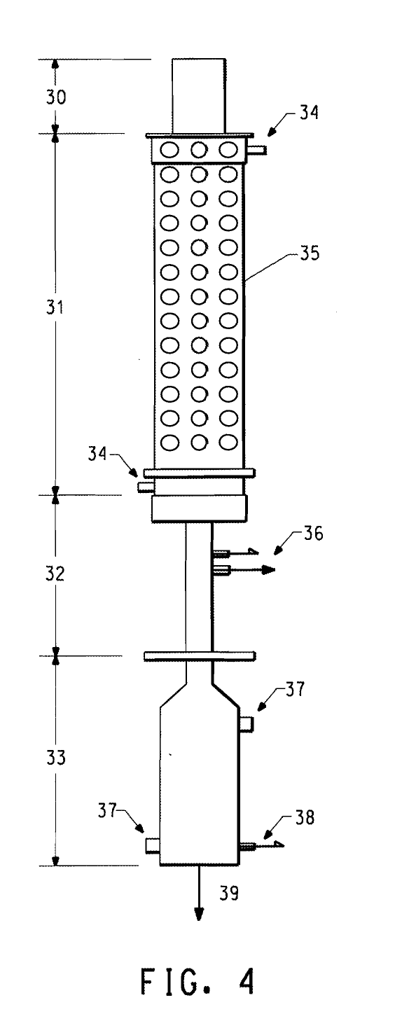

While the nozzle assembly 9, as described above, provides a convenient arrangement for effecting the reaction followed by rapid quenching, it may be replaced by a simple reaction chamber, possibly with multiple ports arranged longitudinally along the flow path in order to permit variability in the position of introduction of the metal carbonyl. Such a multiport reaction chamber is illustrated in FIG. 4, and is provided with a series of input ports arranged linearly in the direction of flow to permit introduction of the metal carbonyl at variable distances from the input of the main methane feed. The reaction chamber of FIG. 4 contains a plasma gun 30, a multi-port reactor 31, an adapter 32, a product collector 33, cooling ports 34, feed ports 35, instrumentation connections 36, cooling ports 37, an instrumentation connection 38, and an exit to scrubber 39.

It is preferred that all materials employed in the operation of the process of this invention be of high purity in order to avoid contamination in the highly reactive environment produced therein.

The advantageous effects of this invention are demonstrated by a series of examples, as described below. The embodiments of the invention on which these examples are based are illustrative only, and do not limit the scope of the appended claims. Unless otherwise specified, all chemicals and reagents were used as received from Aldrich Chemical Co., Milwaukee, Wis.

### Example 1

A composition of carbon nanosheets and core-shell particles was made by a thermal plasma system that used argon as the plasma gas, methane as the hydrocarbon and iron pentacarbonyl as the metal carbonyl source. The plasma reactor had a water-cooled copper cathode with a thoriated tungsten tip and a water-cooled copper anode. An axial magnetic field was applied to the electrodes to maintain a rotating arc for even wear on the anode.

To make the composition, argon was fed through the torch at a variable rate between 12.5 to 50 LPM that averaged about 14 LPM. Below the plasma torch was a 1.5-inch spacer with three 0.125-inch radial feed ports. One of these feed ports was used to feed methane into the argon plasma leaving the plasma torch at a variable rate between 0.1 to 2.0 LPM that averaged about 0.3 LPM. The other two ports in the spacer were capped. Below the spacer was a 3-inch nozzle holder that housed a ceramic nozzle. The nozzle had three radial input ports. Iron pentacarbonyl was fed into one of the feed ports through a bubbler using 100 sccm (40 on the rotometer) of methane as a carrier gas and about 0.2 LPM of methane as a “make-up” gas. The other two ports were capped.

The ceramic nozzle was designed to give one-dimensional axial flow with very little back mixing. Methane that was fed into the argon plasma dissociated and was the source of hydrocarbon to make the product of this invention. Iron pentacarbonyl that was fed into one of the nozzle's input ports readily dissociated above 250° C. and was the source of metal carbonyl needed to make the product of this invention. Product started to form where the hydrocarbon was injected into the nozzle. The nozzle provided fast cooling of the product that was formed by converting heat stored therein into forward motion of the product. At the output of the nozzle was a quench chamber with three radial feed ports. Helium was fed into each of the feed ports at a variable rate of 10 to 15 LPM that provided a total helium feed rate that averaged 15 LPM. The product was then collected in a 3-micron sintered Inconel® 600 filter element located downstream.

### Example 2

The composition of this invention was also produced with a multiport plasma reactor without a nozzle. The feed and catalyst injection ports were located approximately the same as for the nozzle reactor. All feed rates were the same as stated above.

The product of Examples 1 was tested for surface area and size distribution, and those results were compared to the corresponding values obtained for various samples of commercial carbon black and acetylene black.

The surface areas of powders and solids are calculated using the adsorption of nitrogen at its boiling point via the BET method. A Micromeritics ASAP 2405 (a trademark of Micromeritics, Inc., Atlanta, Ga.) adsorption apparatus is used to measure the amount of nitrogen sorbed; and the equation of the BET method is used to calculate the amount of nitrogen corresponding to a monolayer for a given sample. Using an area of 16.2 \dot{A}² per nitrogen molecule under the sorption conditions, the surface area per gram of solid is calculated. Surface area standards from the National Institute of Standards & Technology are run to insure that the reported values are accurate to within a few percent. For non-porous solids (nearly spherical or cubical), the surface area calculated by the BET method can be compared with the size obtained from another technique (e.g. microscopic or particle size analysis). The relationship is

$$SA = \frac{6}{ρ * D}$$

where SA is the surface area in m²/g, ρ the density in g/cc, and D the diameter in microns (μm). This relationship is exact for spheres and cubes. Therefore, the higher the surface area the smaller the size of the primary unit in the powdery material.

The size distribution of the primary unit of solid material contained in a liquid suspension may be determined using a Microtrac Analyzer, which uses the principle of dynamic light scattering. The instrument is manufactured by Leeds and Northrup, North Wales, Pa. The measured size range is 0.003 μm to 6 μm (3 nm to 6000 nm). The powdery sample needs to be prepared into a liquid dispersion to carry out the measurement. An example procedure is as follow:

(1) weigh out 0.08 g dry powder;

(2) add 79.92 g 0.1% surfactant solution in water to make a 0.1 wt % suspension;

(3) sonify the suspension for 1 minute using an ultrasonic probe; the suspension should be cooled in a water-jacketed beaker during sonication; and

(4) when sonication is complete, draw an aliquot for analysis.

Carbon black (Ketjen® 600) was purchased from Akzo-Nobel, Chicago, Ill., and acetylene black was purchased from Cabot Corporation, Billerica, Mass., and both were tested along with samples of the product of this invention according to the procedures described above. The results are presented in the following table.

TABLE 1

| | | Ketjen black | Acetylene |
|---|---|---|---|
| | Example 1 | 600 | black |
| Surface area, m²/g | 234.35 | 1421.98 | 80.42 |
| D₁₀, nm | 100.6 | 196.2 | 291.2 |
| D₅₀, nm | 211.2 | 377.6 | 5014.9 |
| D₉₀, nm | 354.4 | 601.3 | >8000 |

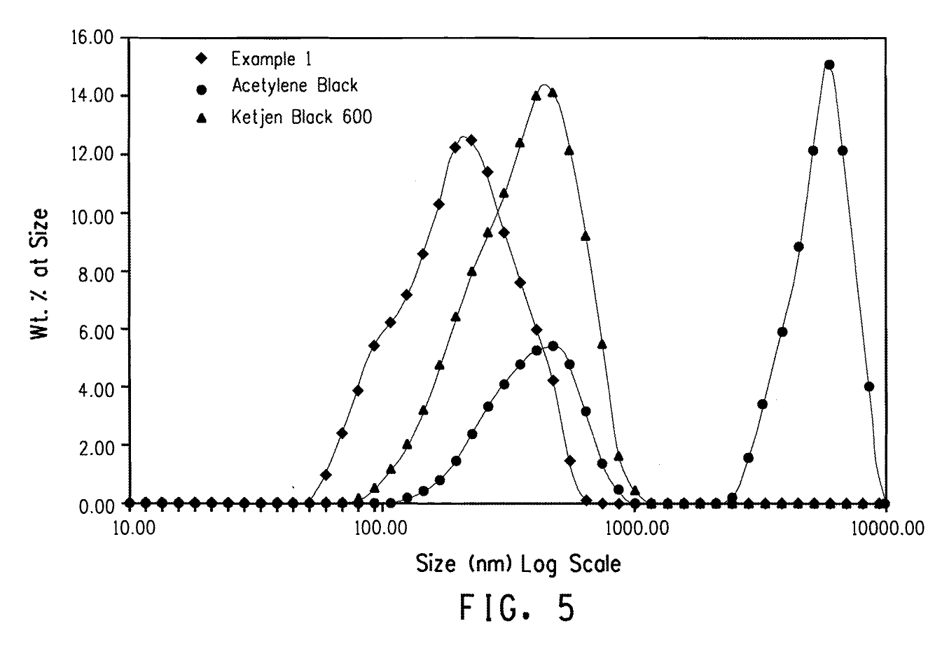

The surface area of the composition as produced by this invention is lower than that of Ketjen carbon black 600 indicating a larger size for its primary unit. However the dispersible size of the primary unit of the composition of this invention is smaller than that for Ketjen carbon black 600, suggesting this composition can be more easily dispersed. The size distribution comparison is given graphically in FIG. 5.

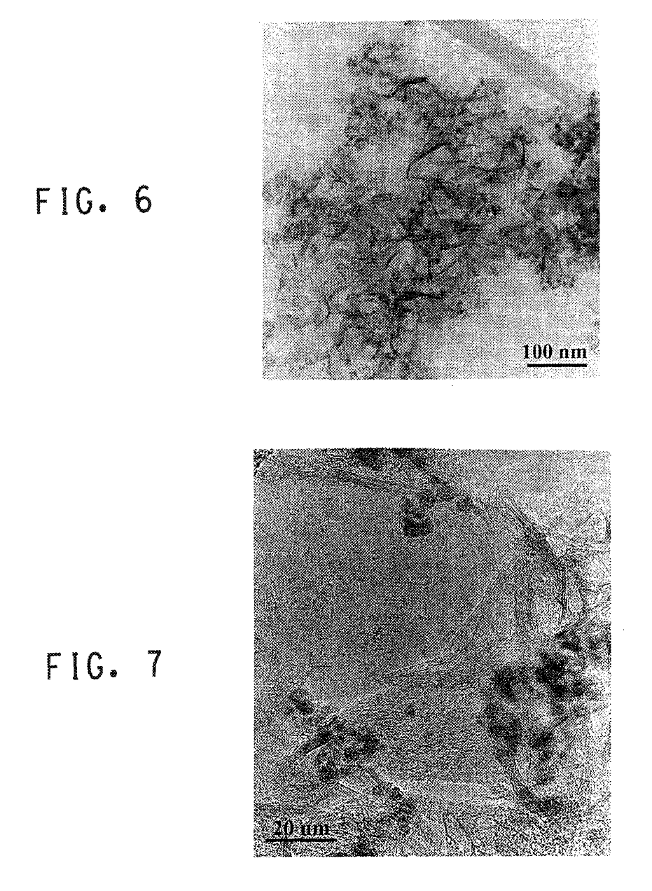

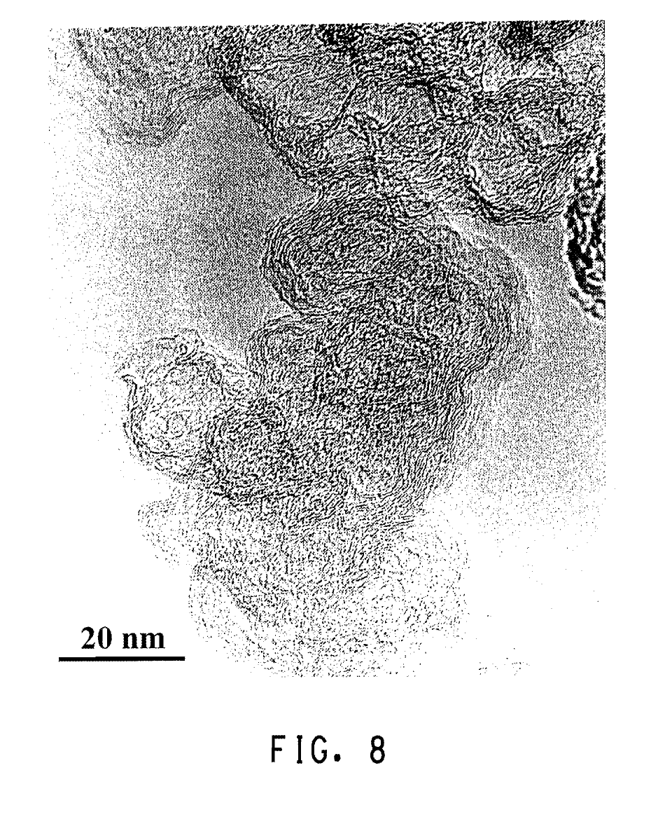

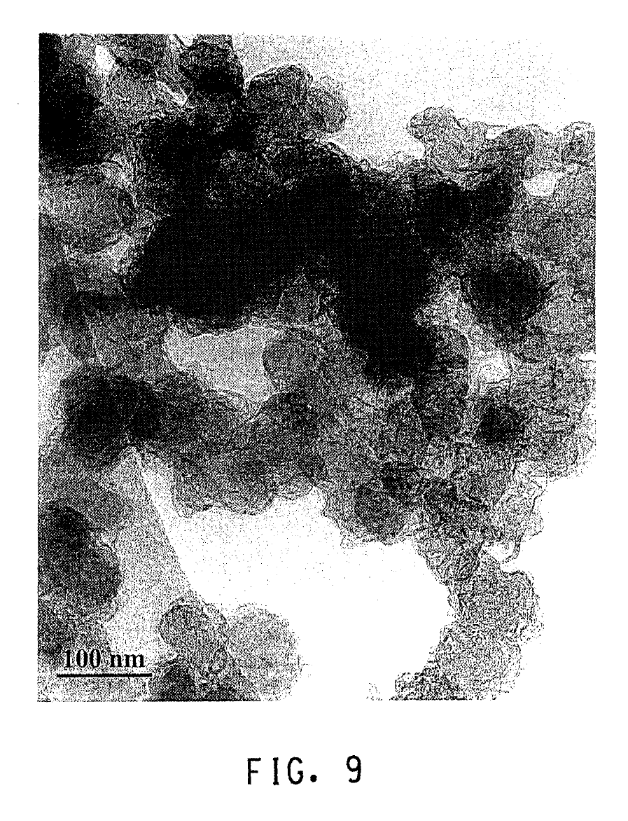

TEM micrographs of the material produced in Example 1 are shown in FIGS. 6 and 7. TEMs of Ketjen carbon black 600 and acetylene black are shown, respectively, in FIGS. 8 and 9. As shown in FIG. 6, the product of this invention has an unmistakable sheet-like structure that exhibits a large number of sharp edges, and the presence of core-shell particles is indicated as well. In FIG. 7, the lattice fringes indicate the crystalline nature of this material. This material has a structure that is different from the carbon black and acetylene black particles shown in the other TEMs. The sheet structure with sharp edges of the product of this invention indicates that this material is very dispersible and highly active.

What is claimed is:

1. A composition comprising (a) carbon nanosheets, and (b) core-shell particles that each comprises a metal-rich core and a carbon-rich shell.

2. A composition according to claim 1 wherein the metal in the core is selected from the group consisting of chromium, cobalt, iron, molybdenum, nickel, tungsten or vanadium.

3. A composition according to claim 1 wherein the core comprises a metal carbide and/or a metal oxide.

4. A composition according to claim 1 wherein a carbon nanosheet has a thickness less than about 10 nanometers.

5. A composition according to claim 1 wherein a carbon nanosheet has a thickness less than about 2 nanometers.

6. A composition according to claim 1 wherein a carbon nanosheet is comprised of about 2 to about 8 graphene plates.

7. A composition according to claim 1 wherein a carbon nanosheet has a lateral dimension between about 25 and about 300 nanometers.

8. A composition according to claim 1 wherein a carbon nanosheet has a surface area, as measured by the Braunauer-Emmett-Teller method, of greater than about 250 m²/g.

9. A composition according to claim 1 which is a free-flowing powder.

10. A composition according to claim 1 which is substantially free of any substrate or support, or any residue or remnant thereof.

11. A process for making a composition according to claim 1 comprising
(a) introducing a hydrocarbon reactant and a metal carbonyl reactant into a flowing gas stream in which the reactants are contacted, and
(b) quenching the reaction of the hydrocarbon and the metal carbonyl to recover the product thereof;
wherein at the point of introduction of the hydrocarbon into the gas stream the gas is in the form of a plasma; and
wherein the metal carbonyl is introduced downstream from the hydrocarbon.

12. A process according to claim 11 wherein at the point of introduction of the metal carbonyl the gas stream is at a temperature of at least about 1000° C.

13. A process according to claim 11 wherein the hydrocarbon comprises a C₁˜C₅ alkane.

14. A process according to claim 11 wherein the hydrocarbon is methane.

15. A process according to claim 11 wherein the metal carbonyl comprises a transition metal carbonyl.

16. A process according to claim 11 wherein the metal carbonyl is iron pentacarbonyl.

17. A process according to claim 11 wherein the metal carbonyl is cooled to below room temperature before being introduced into the gas stream.

18. A process according to claim 11 wherein the metal carbonyl, when introduced into the gas stream, further comprises a carrier gas.

19. A process according to claim 18 wherein the carrier gas comprises a hydrocarbon.

20. A process according to claim 11 wherein the hydrocarbon is bubbled through liquid metal carbonyl.

21. A process according to claim 11 wherein the plasma is formed form an inert gas.

22. A process according to claim 11 which is run in the substantial absence of hydrogen.
